(19) United States
(12) Patent Application Publication
(10) Pub. No.: US 2024/0165835 A1
(43) Pub. Date: May 23, 2024

(54) INDUSTRIAL BOX TOP OPENER

(71) Applicant: Instant Brands Holdings Inc., Downers Grove, IL (US)

(72) Inventors: Michael Sean Run, Chicago, IL (US); Tania Louise Aldous, Niles, IL (US); Shane Unen, Oak Forest, IL (US)

(21) Appl. No.: 18/058,592

(22) Filed: Nov. 23, 2022

(51) Int. Cl. B26B 5/00; B25G 1/10; B26B 29/02

(52) U.S. Cl. CPC B26B 5/005; B25G 1/102; B26B 29/02; B25G 1/08

(57) ABSTRACT

An industrial box top opener having a housing body, an opening therein through which a utility blade partially extends, a retractable shield rotatably coupled to the housing body, and one or more grips is provided. By some approaches, the retractable shield can move or rotate between an extended state where it covers the portion of the utility blade extending from the opening of the housing body to a retracted state where the retractable shield is retracted into the internal cavity of the housing body through the opening and at least a portion of the utility blade is exposed. In one illustrative embodiment, the grips of the housing body include a first grip and a second grip. The second grip having a first gripping pattern and a second gripping pattern.

### FIELD

The present application relates to the field of hand tools including cutting tools, such as utility style cutting tools capable of cutting through light and medium weight materials such as cardboard, and more specifically cardboard boxes.

### BACKGROUND

Cutting tools with blades that can cut through lightweight and medium weight materials, such as cardboard, are widely known. Such cutting tools include utility knives, folding knives, and snap knives that are typically employed in light of their compact configuration, the capability of replacing their blades, and their ability to cut through a variety of materials. However, utility knives, folding knives, and snap knives are often designed to serve a variety of purposes or uses. Indeed, such tools are often specifically designed to cut a wide variety of materials in a variety of locations.

Therefore, while utility knives, folding knives, and snap knives may be utilized to cut a material, such as cardboard, or a specific object made of a specific material, such as a cardboard box, it is often a relatively inefficient and even ineffective process. Further, as utility knives, folding knives, and snap knives have been designed to serve a variety of purposes and be portable and compact, they have not been designed to remove the tops, including the flaps, of boxes to provide greater efficiency and greater ease of box access.

Therefore, a cutting tool that has been specifically designed to perform the task of repeatedly cutting open tops of cardboard boxes to expose the contents therein as efficiently and effectively is of interest. Further, such a cutting tool that is ergonomic and comfortable for repeated use thereof is another advantage of interest.

### BRIEF DESCRIPTION OF THE DRAWINGS

Disclosed herein are embodiments of systems and apparatus pertaining to an industrial box top opener. The description includes drawings, wherein:

FIG. 1 is a front view of an industrial box top opener cutting into the top of a cardboard box according to one aspect of the present application;

FIG. 2 is a front perspective view of the bottom of the industrial box top opener illustrated in FIG. 1;

FIG. 3 is a back perspective view of the bottom of the industrial box top opener illustrated in FIG. 1;

FIG. 4 is a is a front perspective view of the top of the industrial box top opener illustrated in FIG. 1;

FIG. 5 is a bottom view of the industrial box top opener illustrated in FIG. 1;

FIG. 6 is a front view of the industrial box top opener illustrated in FIG. 1;

FIG. 7 is a rear view of the industrial box top opener illustrated in FIG. 1;

FIG. 8 is a side view of a first side of the industrial box top opener illustrated in FIG. 1; and

FIG. 9 is a side view of a second side of the industrial box top opener illustrated in FIG. 1 showing the side opposite the first side of the industrial box top opener shown in FIG. 8;

FIG. 10 is a top-down cross-sectional view of the industrial box top opener illustrated in FIG. 1;

FIG. 11 is a bottom-up cross-sectional view of the industrial box top opener illustrated in FIG. 1;

FIG. 12 is an elevation exploded view of the industrial box top opener illustrated in FIG. 1; and

FIG. 13 is an elevation exploded view of the industrial box top opener illustrated in FIG. 1 showing the opposite side of the industrial box top opener illustrated in FIG. 12.

While the present application discloses certain preferred embodiments, there is no intent to limit it to those embodiments. On the contrary, the intent is to cover all alternatives, modifications and equivalents as included within the spirit and scope of the disclosure made in the present application as defined by the appended claims.

### DETAILED DESCRIPTION

Generally speaking, an industrial box top cutter or opener is provided, including a housing body and a blade holder coupled to the housing body. The blade holder is configured to receive a utility blade so that the cutting edge of the utility blade extends from the housing body when the utility blade is coupled to the blade holder. In addition, the housing includes one or more grips or gripping elements as described below.

In some configurations, the industrial box top opener includes a retractable shield configured to cover at least a portion of the utility blade extending from the housing body when the retractable shield is in an extended state. In this manner, when the retractable shield is in the extended state it prevents the blade from accidentally cutting or damaging something, whereas when the retractable shield is moved to the retracted state, it exposes at least a portion, such as a cutting edge of the utility blade.

As noted above, by some approaches, the housing body of the industrial box top opener includes one or more grips or gripping elements. In one illustrative approach, the industrial box top opener includes a first grip and a second grip.

In another aspect, at least one of the grips may extend over an edge of the industrial box top opener such that the grip extends from one surface of the housing body to another surface of the housing body. In one illustrative example, the industrial box top opener includes a first grip extending at least partially along a top surface of the housing body, at least partially along a first side of the housing body, and at least partially along a bottom surface of the housing body. By one approach, the first grip includes a repeating pattern with a plurality of valleys having a first angular surface and a second angular surface. The first angular surface and the second angular surface of the first grip meeting to form a lowermost portion of the valley.

In still yet another illustrative example, the industrial box top opener includes a second grip having a first gripping pattern that extends at least partially along a top surface of a shelf extending from the housing body and having a plurality of discrete protrusions. In yet another illustrative example, the second grip has a second gripping pattern that extends at least partially along a front surface of the shelf that is generally perpendicular to the top surface of the shelf and includes a repeating pattern of ridges or gullies.

According to another aspect, the industrial box top opener includes a housing body with one or more portions thereof, such as, for example, a first shell coupled to a second shell. In some approaches, the housing body has an opening aligned with a retractable shield, which also has an opening therein. In some approaches, the openings are generally perpendicular to a shelf of the first shell and generally parallel to a sidewall of the second shell. The industrial box top opener further includes a blade holder located within the interior of the housing body. By some approaches, the blade holder is configured to receive a utility blade such that a portion of a cutting edge of the utility blade extends from the opening in the housing body when the utility blade has been received by the blade holder.

As suggested, the industrial box top opener also may include a retractable shield extending from the opening in the housing body and configured to be disposed around the utility blade when in an extended state. By some approaches, the retractable shield includes two positions: an extended position and a retracted position. The retractable shield also may have an opening therein, through which a portion of the blade may extend when the retractable shield is in the retracted position.

In yet another aspect, the industrial box top opener may further include a locking mechanism configured to engage with the retractable shield when the retractable shield is in an extended state to prevent the unintentional rotation of the retractable shield from the extended state to a retracted state where the retractable shield is no longer disposed around the utility blade. In this manner, the device may be more safely transported and stored.

In still yet another aspect, the industrial box top opener may include a shield release button disposed on the exterior of the housing body. By some approaches, the shield release button is configured to engage with the locking mechanism so that when the shield release button is actuated the locking mechanism disengages with the retractable shield so that the retractable shield can be rotated from the extended state to the retracted state.

In some configurations, the industrial box top opener includes a grasping block to assist with retaining the device in position relative to the user's hand. In this manner, the grasping block may include a top surface and a bottom surface that extend between a generally flat front surface and a generally curved back surface to form a generally oblong shape that is configured to receive a Purlicue of a hand.

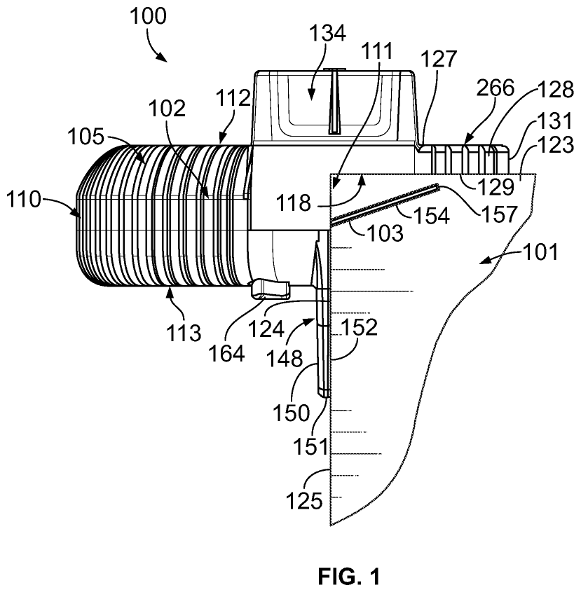

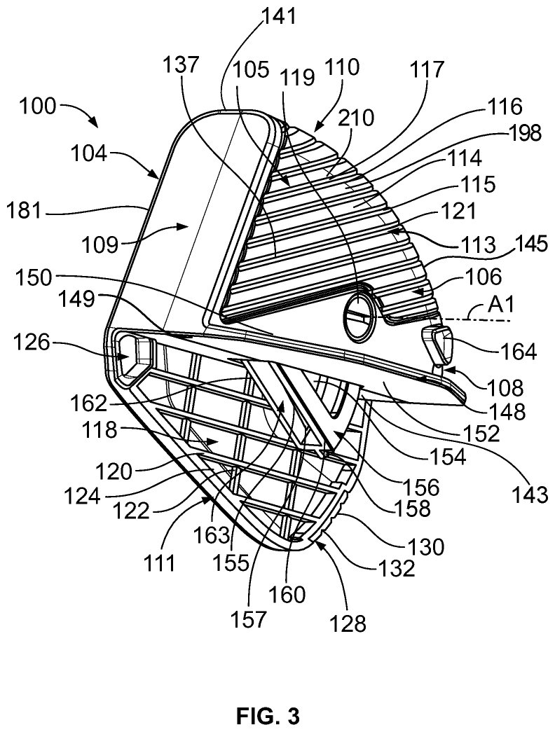

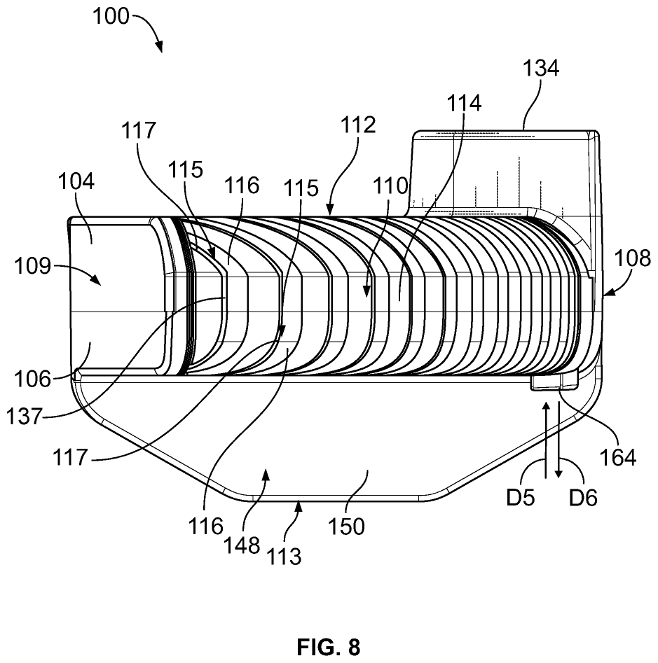

Turning to FIGS. 1-9 illustrating one embodiment of an industrial box top cutter or opener 100 according to one aspect of the present application. FIG. 1 illustrates an industrial box top opener 100 having a housing body 102 that is engaging with portions of a container to be opened, such as, e.g., a cardboard box 101. In use, the industrial box top opener 100 typically engages two adjacent sides or surfaces of a cardboard box 101, such as, e.g., a first side 123 and a second side 125 of a box 101. More specifically, the housing body 102 engaged with the first side 123 and the second side 125 of the box 101 in such a manner that a portion of a utility blade 154 that extends from an opening 163 (FIG. 3) in the housing body 102 is disposed such that a cut 103 is formed through the second side 125 of the box 101 upon application of sufficient force of the industrial box top opener 100 on the cardboard box 101 as the implement is run along the surface to be cut.

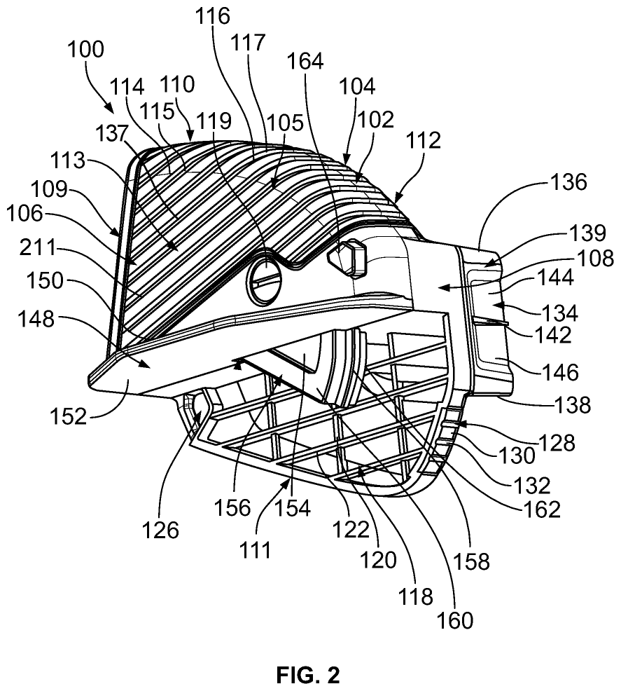

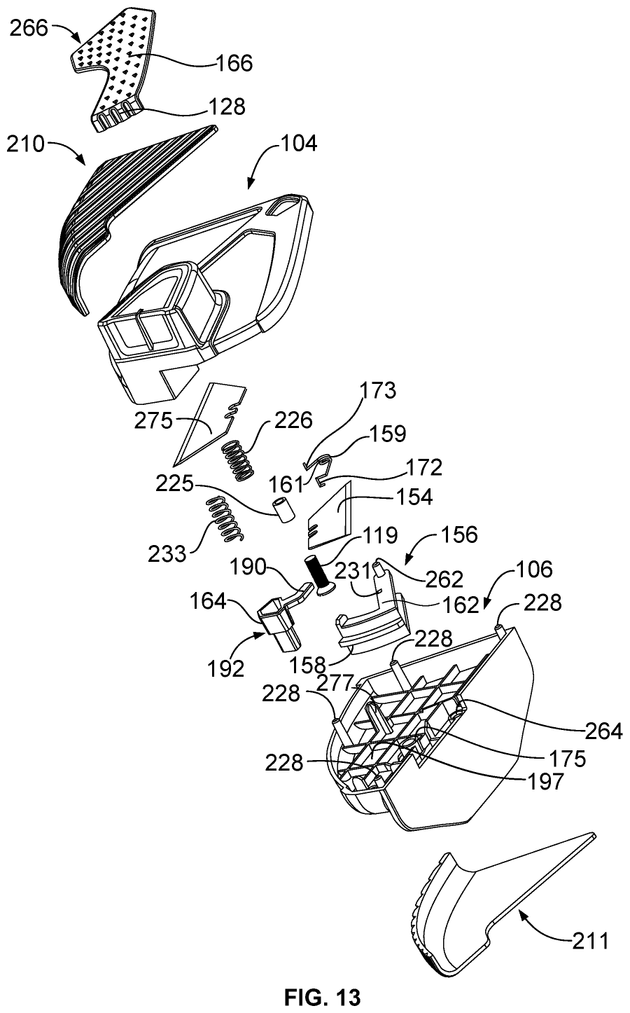

Turning to FIGS. 2 and 3, the housing body 102 includes a front 108, a back 109, a first side 110, a second side 111, a top 112 and a bottom 113. Further, the housing body 102 is typically comprised of a first shell 104 and a second shell 106. The first shell 104 and the second shell 106 are typically configured to be removably couplable to one another using a coupler 119, such as, e.g., a rivet, screw or other fastener. The coupler 119 may pass through opening 175 provided on the second shell 106 and couple with a coupling mechanism 225 (FIG. 13) located in an aperture 176 provided along the interior surface of the first shell 104. The first shell 104 and the second shell 106 may be composed of any material generally known in the art and formed using any means generally known in the art.

According to one approach, the first shell 104 and the second shell 106 can be made from a plastic material. In some configurations, the plastic material used for the first shell 104 and the second shell 106 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), a Polystyrene (PS or Styrofoam), and/or combinations thereof. In yet another aspect, a molding process (such as plastic molding processes known in the art) can be used to form the first shell 104 and the second shell 106.

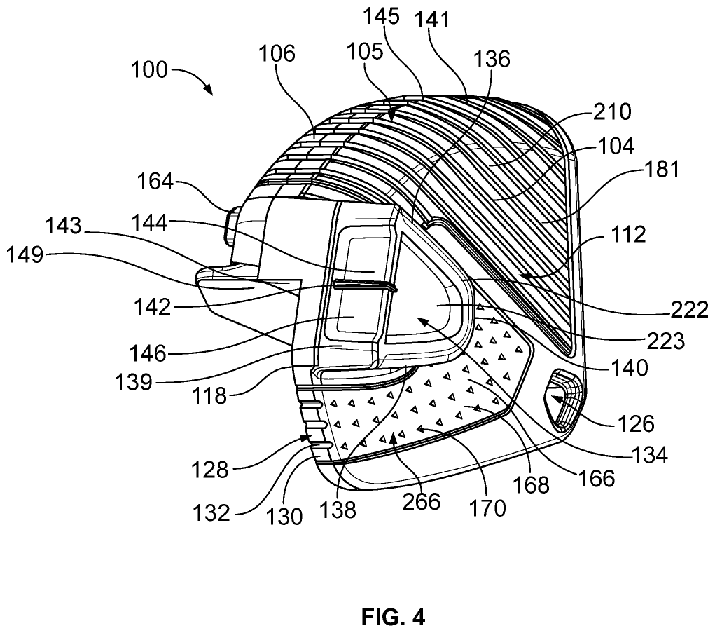

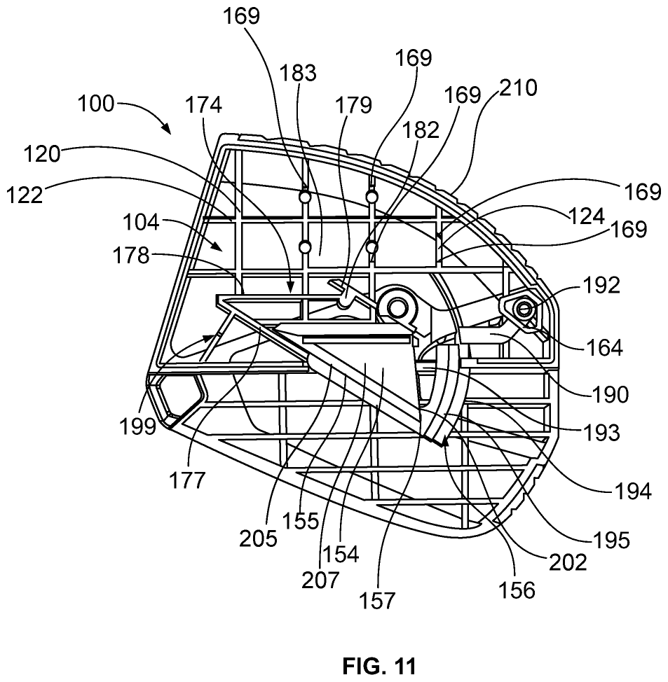

With reference to FIGS. 3, 4, and 11, the first shell 104 includes a top 181 (FIG. 3), a bottom 183 (FIG. 11), a first side 141 (FIG. 4), and a second side 143 (FIG. 3). In one illustrative example, the first shell 104 includes an overhang or a shelf 118 that extends from the second side 143 of the first shell 104. The shelf 118 having a top surface 127, a bottom surface 129, and a terminal end 131. The bottom surface 129 of the shelf 118 providing a generally straight surface that is configured to engage and abut against the generally straight surface of the first side 123 of a box 101 (FIG. 1). In some configurations, the shelf 118 extends above and beyond the blade 154 and the retractable shield 156 disposed therearound. In this manner, when the blade 154 is exposed the shelf 118 and other elements (such as the guide or sidewall 148) help ensure proper placement of the blade 154 to avoid personal injury and unintentional property damage.

In some aspects, the shelf 118 further includes an aperture 126 that extends through the shelf 118. In one configuration, the aperture 126 extends through the shelf 118 such that it can be used to couple an object to the industrial box top opener 100, such as, e.g., a carabiner or rope. In such a configuration, the carabiner may be employed to further couple the industrial box top opener 100 to another item such as a belt loop or hook. The aperture 126 also may be used to hang the industrial box top opener 100 directly on a nail or a peg.

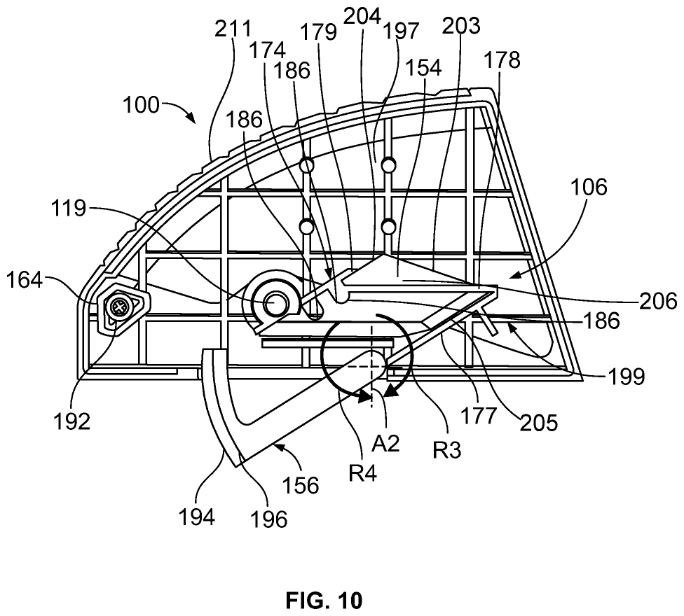

By some approaches, the second shell 106 includes a top 197 (FIG. 10), a bottom 198, a first side 145, and a second side 149. The second shell 106 also typically includes a guide or a sidewall 148 that extends from the second side 149 of the second shell 106. The sidewall 148 including a first side 150, a second side 152, and a terminal end 151. The second side 152 of the sidewall 148 providing a generally straight surface that is configured to engage and abut against the generally straight second side 125 of a box 101 (FIG. 1) that is to be cut using the industrial box top cutter 100. In this manner, the sidewall 148 guides or directs the user's movement of the industrial box top opener 100 during use thereof.

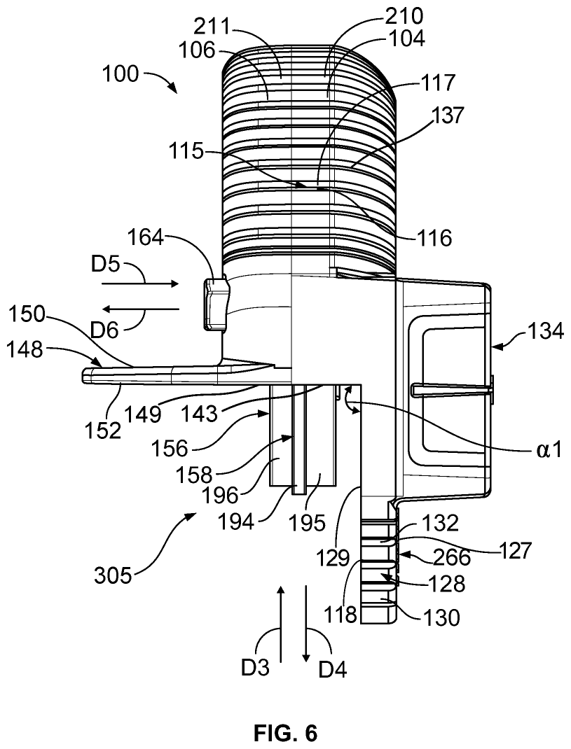

As shown in FIG. 6, the second side 143 of the first shell 104 and the bottom surface 129 of the shelf 118 are configured to form an angle α₁. In some configurations, the angle α₁ is about 85° to about 95°. In one illustrative approach, the angel α₁ is about 90° or very close to 90°, such as, e.g., just slightly larger than 90°. As will be appreciated, having an angle α₁ at about 90° typically provides sufficient space on or at a receiving area 305 formed at a portion of the housing body 102 disposed between the second side 149 and the bottom surface 129. By having a sufficiently sized receiving area 305 the industrial box top opener 100 is configured to engage with exterior surfaces of numerous differently sized and configured boxes 101. For example, many shipping containers or boxes have sides 123, 125 that meet to form an edge having an angle that is about 90° including commonly used square or rectangular cardboard boxes.

As illustrated in the embodiment of FIG. 4, the industrial box top opener 100 may further include a grasping block 134. In one illustrative approach, the grasping block 134 extends from a top 112 of the housing body 102 and/or front 108. The grasping block 134 typically includes a front surface 139, a back surface 140, a first side 136, a second side 138, and a top 222. The grasping block 134 having a generally oblong shape. The generally oblong shape being tapered between the front surface 139 and the back surface 140, such that the front surface 139 has a surface area that is larger than the surface area of the back surface 140.

The front surface 139 having a generally flat shape and the back surface 140 having a generally curved surface. In one configuration, the purlicue of a user's hand or the portion of a user's hand located between the base of their thumb and the base of their pointer finger will engage with the generally curved back surface 140 of the grasping block 134 when the user is grasping the industrial box top opener 100. In another configuration, the inner side of the user's pointer finger will engage with the first side 136 of the grasping block 134 and the inner side of the user's thumb will engage with the second side 138 of the grasping block 134 when the user is grasping the industrial box top opener 100.

The front surface 139 of the grasping block 134 further including a first surface depression 144 and a second surface depression 146. In one configuration, the first surface depression 144 can be engaged by one of a user's fingers to provide an additional grasping point when the user is grasping the industrial box top opener 100.

In another configuration, the first surface depression 144 can be engaged by the pointer finger of a user when the user is grasping the industrial box top opener 100. In another configuration, the second surface depression 146 can be engaged by a user's thumb when the user is grasping the industrial box top opener 100. In another configuration, the second surface depression 146 can be engaged by the terminal end of a user's thumb when the user is grasping the industrial box top opener 100.

The front surface 139 of the grasping block 134 further including a projection 142 that extends between the first surface depression 144 and the second surface depression 146. In one configuration, the projection 142 extending between the first surface depression 144 and the second surface depression 146 can be used as an indicator of where the sidewall 148 is relative to a second side 125 of a box 101 being cut so that a user can ensure that the second side 125 of the box 101 is as flush as possible with the sidewall 148. In another configuration, the projection 142 extending between the first surface depression 144 and the second surface depression 146 can be used as an indicator of where the base of the portion of the utility blade 154 extending from the opening 163 in the housing body 102 is relative to a second side 125 of a box 101 being cut so that the user can ensure that the portion of the utility blade 154 extending from the opening 163 in the housing body 102 is close enough to the second side 125 of the box 101 so that the portion of the utility blade 154 extending from the opening 163 of the housing body 102 is cutting through the second side 125 of the box 101.

The top 222 the grasping block 134 further including a third surface depression 223. In one configuration, the third surface depression 223 can be engaged by a user's thumb when the user is grasping the industrial box top opener 100. In another configuration, the third surface depression 223 can be engaged by the terminal end of a user's thumb when the user is grasping the industrial box top opener 100.

With reference to FIGS. 2-4, the housing body 102 further comprising a first grip 105. As shown, the first grip 105 extends at least partially along the top 112, first side 110, and bottom 113 of the housing body 102. In one exemplary embodiment, the first grip 105 includes a textured surface having a linear repeating pattern of ridges 114 and valleys 115. In one approach, the ridges 114 of the first grip 105 will include a first angular side 116 and a second angular side 117 that meet to form a valley or lowermost point 137 of the ridges 114.

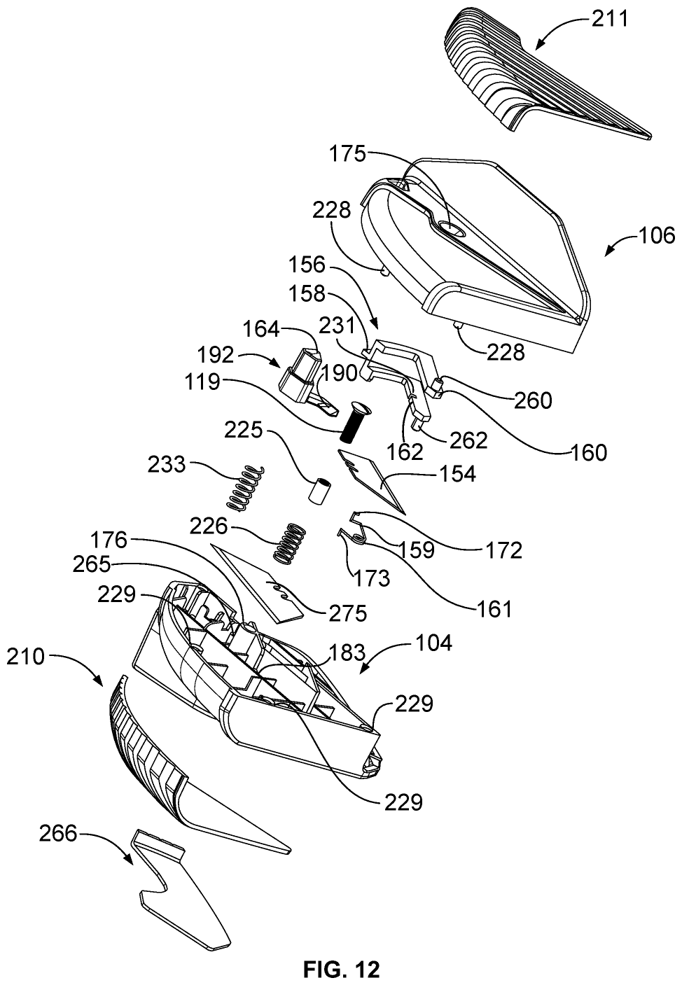

The first grip 105 is composed of a first grip element 210 (FIGS. 12 and 13) provided on the first shell 104 and a second grip element 211 (FIGS. 12 and 13) provided on the second shell 106. The first grip element 210 and the second grip element 211 are configured so that when the first shell 104 and the second shell 106 are properly aligned and coupled together the first grip element 210 and the second grip element 211 come together to form the first grip 105 on the housing body 102.

Advantageously, the repeating pattern of ridges 114 and valleys 115 of the first grip 105 act to provide an additional amount of friction or traction against a user's hand when gripping the housing body 102 of the industrial box top cutter 100. More specifically, the repeating pattern of ridges 114 and valleys of the first grip 105 provide an additional manner of leveraging the grip between a user's hand or fingers and the housing of the industrial box cutter 100.

The first grip 105 can be composed of any material generally known in the art and formed using any means generally known in the art. According to one approach, the first grip 105 can be formed from a plastic material. In another approach, the plastic material used to form the first grip 105 can be an Acrylonitrile Butadiene Styrene (ABS), a Polyethylene Terephthalate (PET or PETE), a High-Density Polyethylene (HDPE), a Polyvinyl Chloride (PVC or Vinyl), a Low-Density Polyethylene (LDPE), a Polypropylene (PP), or a Polystyrene (PS or Styrofoam).

In one approach, the first grip 105 can be formed during the same process used to make the first shell 104 and the second shell 106, such that that the first grip 105 is formed from the same piece of material, such as a piece of plastic material, that is used to make the first shell 104 and the second shell 106. In another approach, the first gripping surface can be formed in a process that is separate from the process used to form the first shell 104 and the second shell 106, such that the first grip 105 is formed from a separate or non-continuous piece of material than the pieces of material, such as a plastic material, that form the first shell 104 and the second shell 106. In yet another approach, the first grip 105 can be composed of a second material, such as a second plastic material, that is overmolded on the first piece of material, such as a first plastic material, that is used to make the first shell 104 and the second shell 106. In still yet another approach, the first grip 105 can be made from a second plastic material made from a Thermoplastic Elastomer (TPE) or a Thermoplastic Rubber (TPR).

In some configurations, the housing body 102 further includes a second grip 266 (FIG. 4) extending at least partially along a top 112 of the housing body 102 and at least partially along a front 108 of the housing body 102. The second grip 266 including a first gripping pattern 166 that extends at least partially along the top 112 of the housing body 102. The first gripping pattern 166 having a generally smooth surface 168 with a plurality of discrete protrusions 170 disposed thereon. The plurality of discrete protrusions 170 may be, but are not required to be, uniformly spaced out along the surface of the generally smooth or flat surface 168 of the first gripping pattern 166. The plurality of discrete protrusions 170 may be any shape generally known in the art, such as, but not limited to being triangular in shape. The second grip 266 may be formed in a similar manner to those described above with respect to the first grip 105.

Advantageously, the plurality of discrete protrusions 170 disposed on the first gripping pattern 166 act to provide an additional means of traction to a user's hand when gripping the housing body 102 of the industrial box top opener 100. More specifically, the plurality of discrete protrusions 170 disposed on the first gripping pattern 166 provide an additional means of friction or traction to the thumb and the palm of the user's hand when the user is gripping the grasping block 134 between the user's thumb and pointer finger, as discussed above.

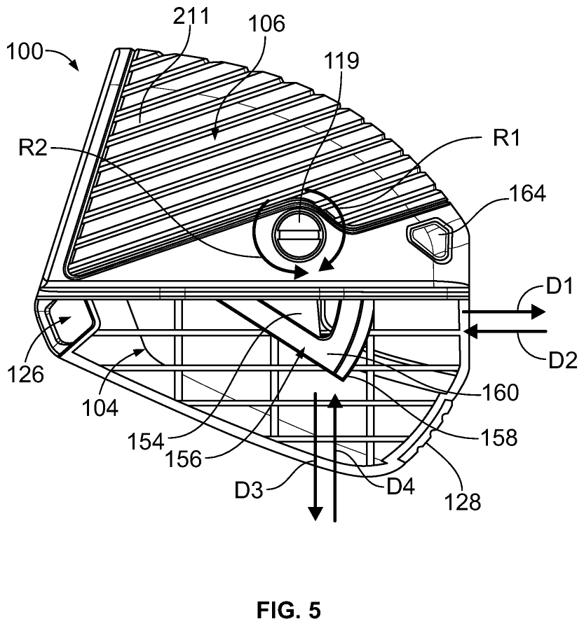

In some configurations, the second grip 266 includes a second gripping pattern 128 (FIG. 4). The second gripping pattern 128 may extend at least partially along a front 108 of the housing body 102 and include a plurality of ridges or fins 130 interspersed between a plurality of notches, depressions, or gullies 132. The second gripping pattern 128 typically provides an additional traction to the terminal end of a user's thumb when gripping the housing body 102 and acts as an additional pulling point for the user to grip when pulling the industrial box top cutter 100 in direction D2 (FIG. 5) along the surface of the box 101 being cut. In one illustrative embodiment, the second grip 266 form the first gripping pattern 166 and the second gripping pattern 128 form two different patterns on a single or unitary grip, which may be molded in one piece. Indeed, a single grip may include both the first gripping pattern 166 and the second gripping pattern 128 such that the second grip 266 has two distinct patterns thereon.

The second grip 266 can be made from any material generally known in the art and formed using any process generally known in the art.

In one approach, the second grip 266 can be composed of a second plastic material that is overmolded directly on the first plastic material making up the first shell 104 of the housing body 102.

In some approaches, the second plastic material used to make the second grip 266 can be a Thermoplastic Elastomer (TPE) or a Thermoplastic Rubber (TPR).

In one aspect, the first gripping pattern 166 and the second gripping pattern 128 of the second grip 266 can be formed during the same overmolding process, such that the first gripping pattern 166 and the second gripping pattern 128 are formed from the same continuous piece of gripping material.

In still yet another aspect, the first gripping pattern 166 can be formed separately from the second gripping pattern 128, such that the first gripping pattern 166 and the second gripping pattern 128 are formed from separate or non-continuous pieces of gripping material.

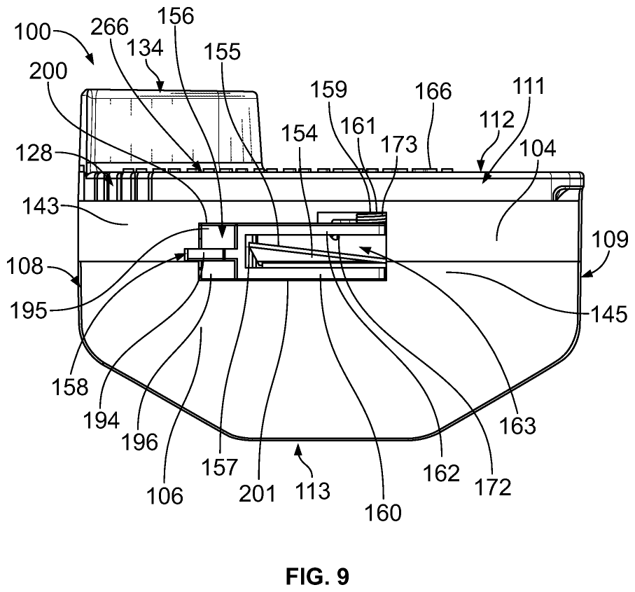

Turning to FIGS. 9 and 10, the second side 143 of the first shell 104 includes a first cutout portion 200 and the second side 149 of the second shell 106 includes a second cutout portion 201 (FIG. 9). When the first shell 104 and the second shell 106 are coupled together the first cut out portion 200 and the second cut out portion 201 are aligned to form an opening 163 that extends into an internal cavity 199 of the housing body 102. The opening 163 is configured to allow the retractable shield 156 to rotate between a first or extended position (FIG. 2) in which the retractable shield 156 extends out of the opening 163 and a second or retracted position (FIG. 1) in which the retractable shield 156 is retracted at least partially into the internal cavity 199 of the housing body 102.

By one approach, the retractable shield 156 includes a first arm 160 and a second arm 162 with a front cover 158 (FIG. 6) extending therebetween. The first arm 160 has a first projection 260 and the second arm 162 has a second projection 262. The first projection 260 and the second projection 262 extend from the outside of their respective first arm 160 and second arm 162 (FIGS. 12 and 13). The projections 260,262 are configured to rotatably couple the retractable shield 156 to apertures 264, 265 (FIGS. 12 and 13) provided on the housing body 102, such that the retractable shield 156 can rotate about axis A2 (FIG. 10) to move between the retracted position (FIG. 1) and the extended position (FIG. 2).

To move the retractable shield 156 from the extended position (FIG. 2) to the retracted position (FIG. 1) the retractable shield 156 will need to be rotated about axis of rotation A2 in direction R3 (FIG. 10). Likewise, to move the retractable shield 156 from the retracted position (FIG. 1) to the extended position the retractable shield 156 will need to be rotated about axis of rotation A2 in direction R4 (FIG. 10).

In some configurations, the second arm 162 of the retractable shield 156 is further coupled to a biasing mechanism 159 that biases the retractable shield 156 in direction R4 about axis of rotation A2 (FIG. 10). By some approaches, the biasing mechanism 159 includes a first arm 172 and a second arm 173 (FIGS. 12 and 13). In one aspect, the first arm 172 may be configured to be coupled to a notch 231 (FIG. 13) provided on the retractable shield 156 and the second arm 173 may configured to be coupled with the housing body 102, such that the retractable shield 156 may be rotated about axis of rotation A2.

The biasing mechanism 159 may further include a spring 161 positioned between and connected to the first arm 172 and/or the second arm 173. In use, the spring 161 is configured to bias the first arm 172 in direction R4 about axis of rotation A2 (FIG. 10). As will be appreciated, as the spring 161 biases the first arm 172 in direction R4 about axis of rotation A2 it will also bias the retractable shield 156 in direction R4 about axis of rotation A2 when the first arm 172 is coupled with the retractable shield 156.

Therefore, when the biasing mechanism is 159 coupled to the retractable shield 156 it will continue to bias the retractable shield 156 in direction R4 about axis of rotation A2, such that the retractable shield 156 is generally retained in its fully extended position (FIG. 2) until sufficient force is applied on the retractable shield 156 in direction D4 (FIG. 5) to rotate the retractable shield 156 in direction R3 about axis of rotation A2. This will cause the retractable shield 156 to begin to retract into the opening 163 of the housing body 102 until the retractable shield is fully received within the internal cavity 199 of the housing body 102 where the retractable shield 156 will be in its fully retracted position (FIG. 1).

As shown in FIG. 6, the front cover 158 over the retractable shield 156 has an extended surface 194 positioned between a first wall 195 and a second wall 196 where the first wall 195 and the second wall 196 are generally level to one another. In use, the extended surface 194 is configured to engage with the locking arm 190 of a locking mechanism 192 located within the internal cavity 199 (FIG. 11) of the housing body 102, such that when the extended surface 194 is in contact with the locking arm 190 of the retractable shield 156 cannot rotate in direction R3 (FIG. 10) about axis of rotation A2, even if a significant force is applied to the retractable shield 156.

Thus, when the locking arm 190 is in contact with the extended surface 194 it typically prevents the retractable shield 156 from being dislodged or moving from its extended position (FIG. 2) where the retractable shield 156 is covering the portion of the utility blade 154 extending from the housing body 102 to its retracted position (FIG. 1) where the retractable shield 156 does not cover at least a portion of the utility blade 154 extending from the housing body 102. In this manner, the locking arm 190 associated with the lock release button 164 prevents unintentional exposure of the cutting edge 155.

Turning to FIGS. 10,11, 12 and 13, illustrating the locking mechanism 192 (FIG. 11) located in the internal cavity 199 of the housing body 102. As suggested above, the locking mechanism 192 is coupled to a shield or lock release button 164 (FIG. 6) that extends between the bottom 198 and the top 197 of the second shell 106. The lock release button 164 is configured to receive a spring 233 (FIG. 13) that biases the lock release button 164 in direction D6 (FIG. 6). The lock release button 164 includes a locking arm 190 that is located within the internal cavity 199 of the housing body 102. The spring 233 is also configured to bias the locking arm 190 in the second direction D6 (FIG. 6), such that the locking arm 190 and the lock release button 164 will have a natural or resting position in which they will be biased in direction D6. Accordingly, this retains the locking arm 190 in its locked position when it is in its natural or resting position.

To disengage the locking arm 190 from its engagement with the extended surface 194 of the retractable shield 156, a user applies sufficient force onto the lock release button 164 in direction D5 (FIG. 6) to sufficiently shift the locking arm 190 in direction D5 (FIG. 6) so that the locking arm is aligned above the first wall 195 located on the front cover 158 of the retractable shield 156. The first wall 195 of the front cover 158 configured to provide enough clearance between the locking arm 190 and the front cover 158 of the retractable shield 156 to allow the retractable shield 156 to rotate in direction R3 (FIG. 10) about axis of rotation A2.

Once the locking arm 190 has been sufficiently shifted in direction D5 (FIG. 6) to be aligned with the first wall 195 the retractable shield 156 can then be rotated into the retracted state by applying force in direction D3 on the retractable shield 156. The force will need to be sufficient to overcome the biasing force of the spring 161, which, when met, will cause the retractable shield 156 to begin to rotate about axis of rotation A2 in R3 (FIG. 10). As the retractable shield 156 rotates in direction R3 about axis of rotation A2 (FIG. 10) it will start to retract into the opening 163 of the housing body 102. Consistent application of force in detection D3 on the retractable shield 156 will rotate the retractable shield from its fully extended position (FIG. 2) to its fully retracted position (FIG. 1) where the retractable shield 156 will be fully retracted into the internal cavity 199 of the housing body 102. Once the retractable shield 156 has been fully retracted into the internal cavity 199 of the housing body 102 the portion of the utility blade 154 extending from the housing body 102 will be fully exposed where it can be used to cut through a piece of material that it contacts, such as the surface of a box 101 (FIG. 1).

In short, to utilize the industrial box top opener 100 to cut material such as cardboard, a user depresses the lock release button 164 with sufficient force and ensures sufficient force is exerted onto the retractable shield 156 thereby moving it at least partially into the housing to expose the cutting edge 155 of the blade 154. In this manner, several differently aligned forces are exerted onto the industrial box top opener 100 for proper use thereof, which helps prevent unintended exposure of the cutting edge and thereby improves the safety thereof. Further, repeated use of the tool, which requires sufficiently exerting differently aligned forces, may become difficult for some users, particularly those with somewhat limited manual dexterity. To assist users in these regards, the industrial box top opener 100 has a plurality of gipping elements or surfaces as outlined above.

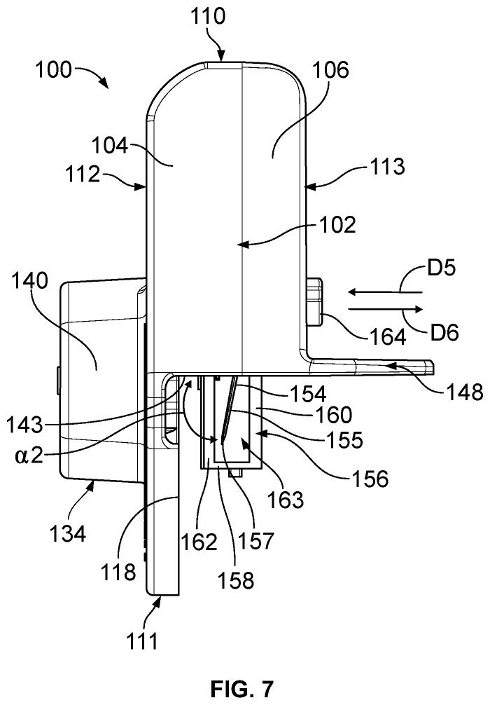

The internal cavity 199 (FIGS. 10 and 11) of the housing body 102 further houses a blade holder 174 (FIGS. 10 and 11) capable of receiving and securing a utility blade 154 within the blade holder 174. As discussed above, the blade holder 174 is coupled to the housing body 102 such that when the utility blade is secured to the blade holder 174 at least a portion of the utility blade 154 will be extending from an opening 163 provided in the housing body 102. In one illustrative configuration, the blade holder 174 is configured to be installed securely within the internal cavity 199 of the housing body in such a manner that the portion of the utility blade 154 that extends from the opening 163 of the housing body 102 has an upward trajectory (FIGS. 1 and 7) toward the shelf 118 of the housing body 102.

The blade holder 174 is configured to receive a utility blade 154 that has a front side 202, a back side 203, a top 204, a bottom 205, a first side 206, and a second side 207 (FIGS. 10 and 11). The top 204 of the utility blade 154 further including notches 186 configured to engage with and couple the utility blade 154 to the blade holder 174. The bottom 205 of the utility blade 154 including a cutting edge 155 and a tip 157 used for cutting pieces of material, such as, but not limited to, the cardboard of a cardboard box 101.

The blade holder 174 includes a first or bottom rail 177 configured to engage with the bottom 205 of the utility blade 154 and a second or top rail 179 configured to engage with the top 204 of the utility blade 154. The top rail 179 further includes a coupling projection 182 (FIG. 11) that extends from the top rail 179. The coupling projection 182 is configured to engage with notches 186 locate along the top 204 of the utility blade 154, such that the coupling projection 182 prevents the movement of the utility blade 154 relative to the blade holder 174 when the coupling projection 182 extends into one of the notches 186 located on the top 204 of the utility blade 154.

In one configuration, the utility blade 154 includes more than one notch 186 located along the top 204 of the utility blade 154, such that the length of the portion of the utility blade 154 that is extending out of the opening 163 of the housing body 102 can be adjusted by changing which notch 186 the coupling projection 182 is extending into. In another configuration, the utility blade will include three notches 186 located along the top 204 of the utility blade 154 so that the utility blade 154 can be coupled to the blade holder 174, such the utility blade 154 can be adjusted on the blade holder 174 to project from the opening 163 of the housing body 102 at three different lengths.

In one configuration, the utility blade 154 extends from the opening 163 of the housing body 102, such that an angle α2 formed between the utility blade 154 and second side 143 of the first shell 104 is less than 90°.

In another configuration, the utility blade 154 extends from the opening 163 of the housing body 102, such that an angle α2 formed between the utility blade 154 and second side 143 of the first shell 104 is greater than 60° but less than 90°. In some configurations, the angle α2 is between about 70° to about 85°.

To form the angle α2, the blade holder 174 has a first shelf 178 (FIG. 11) and a second shelf 193 (FIG. 11) that extend from the bottom 183 of the first shell 104. The first shelf 178 is positioned to engage with a portion of the first side 206 of the utility blade 154 located adjacent to the back side 203 of the utility blade 154 and the second shelf 193 is configured to engage with the first side 206 of the utility blade 154 located adjacent to the front side 202 of the utility blade 154. The first shelf 178 extending from the bottom 183 of the first shell 104 at a first distance, such that when the utility blade 154 is secured to the blade holder 174 the back side 203 of the utility blade 154 is located a first distance from the bottom 183 of the first shell 104. The second shelf 193 extending from the bottom 183 of the first shell 104 a second distance, such that when the utility blade 154 it secured to the blade holder 174 the front side 202 of the utility blade 154 is located a second distance from the bottom 183 of the first shell 104. The first distance that the first shelf 178 extends from the bottom 183 of the first shell 104 being greater than the second distance that the second shelf 193 extends from the bottom 183 of the first shell 104. This causes the back side 203 of the utility blade 154 to be secured to the blade holder 174 at the first distance relative to the bottom 183 of the first shell 104 and the front side 202 of the utility blade 154 to be secured to the blade holder 174 at the second distance relative to the bottom 183 of the first shell 104.

Thus, as the utility blade 154 is secured to the blade holder 174, the back side 203 of the utility blade 154 is located at a first position that is further away from the bottom 183 of the first shell 104 than the front side 202 of the utility blade 154, which causes the front side 202 of the utility blade 154 to extend from the housing body 102 at angle α2 that is pitched toward the bottom 183 of the first shell 104.

The bottom 183 of the first shell 104, which includes the bottom surface 129 of the shelf 118, has a series of supporting ribs 120, 122. In one configuration, the supporting ribs 120, 122 includes vertical crossbars that are intersected by a series of horizontal crossbars. In one configuration, the series of vertical crossbars and horizontal crossbars provide additional structural strength to the bottom 183 of the first shell 104 and the shelf 118. In another configuration, the series of vertical crossbars and horizontal crossbars reduces the friction created between the first side 123 of the box 101 and the bottom surface 129 of the shelf 118 by reducing the surface area on the bottom surface 129 of the shelf 118 that contacts the first side 123 of the box 101 (FIG. 1).

The series of vertical and horizontal crossbars or ribs 120, 122 may also include cutouts 169 that create a cutout portion 124 on some of crossbars. In one configuration, the cutouts 169 will create a cutout portion 124 within the series of vertical and horizontal crossbars or ribs 120,122 that takes the shape of a utility blade 154. In another configuration, the cutout portion 124 within the series of ribs 120,122 have the shape of a utility blade 154 and can be used to secure and store one or more replacement utility blades 275 (FIGS. 12 and 13) within the internal cavity 199 of the housing body 102.

The second shell 106 also includes a projection 277 (FIG. 13) extending from the top 197 of the second shell 106. The projection 277 is configured to be inserted through the interior of a spring 226 (FIG. 13). The projection 277 and the spring 226 are aligned on the second shell 106, such that when the first shell 104 and the second shell 106 are coupled together the spring 226 biases against any replacement utility blades 275 that are being stored in the cutout portion 124 on the bottom 183 of the first shell 104.

The second shell 106 also includes projections 228 that extend from the top 197 of the second shell 106 and the first shell 104 includes corresponding apertures 229 located along the bottom 183 of the first shell 104. The projections 228 and the apertures 229 are configured such that when a user is bringing together the first shell 104 and the second shell 106 the user can align the projections 228 in the second shell 106 with the apertures 229 provided in the first shell 104 to ensure that the first shell 104 and the second shell 106 are properly aligned before coupling together the first shell 104 and the second shell 106 with the coupler 119.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents used in the present application (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate what is being disclosed by the present application and does not pose a limitation on the scope of the disclosure in the present application unless otherwise claimed. No language in the specification should be construed as indicating any non-claimed element as essential to the practice of what is disclosed by the present application.

Preferred embodiments disclosed in the present application are described herein, including the best mode known by the applicants for carrying out what is disclosed in the present application. Variations of those preferred embodiments may become apparent to those of ordinary skill in the art upon reading the foregoing description. The applicants expect skilled artisans to employ such variations as appropriate, and the applicants intend for the disclosure in the present application to be practiced otherwise than as specifically described herein.

Accordingly, the disclosure of this application includes all modifications and equivalents of the subject matter recited in the claims appended hereto as permitted by applicable law. Moreover, any combination of the above-described elements in all possible variations thereof is encompassed by the disclosure of the present application unless otherwise indicated herein or otherwise clearly contradicted by conte

What is claimed is:

1. An industrial box top opener comprising:
a housing body;
a blade holder coupled to the housing body and configured to receive a utility blade, such that at least a portion of a cutting edge of the utility blade extends from the housing body when the utility blade has been received by the blade holder;
a retractable shield configured to cover the cutting edge of the utility blade extending from the housing body when the retractable shield is in an extended state and to expose the portion of the cutting edge of the utility blade when the retractable shield is in a retracted state; and
the housing body including a first grip and a second grip;
wherein the first grip extends at least partially along a top of the housing body, at least partially along a first side of the housing body and at least partially along a bottom of the housing body, the first grip having a repeating pattern with a plurality of linear valleys; and
the second grip having a first gripping pattern that extends at least partially along a top of a shelf extending from the housing body and includes a plurality of protrusions.

2. The industrial box top opener of claim 1, wherein the housing body includes a first shell and a second shell that are coupled together using a coupler and the second grip further includes a second gripping pattern that extends along a front surface of the shelf that is generally perpendicular to the top of the shelf.

3. The industrial box top opener of claim 2, wherein the first shell and the second shell are coupled together to form an opening between the first shell and the second shell, such that the portion of the utility blade extending from the housing body extends through the opening provided between the first shell and the second shell when the utility blade has been received by the blade holder.

4. The industrial box top opener of claim 1, further comprising a biasing mechanism that is configured to bias the retractable shield in the extended state.

5. The industrial box top opener of claim 1, further comprising a shield release button that has a first end that is positioned on an exterior of the housing body and a second end that is coupled to a locking mechanism located within an interior of the housing body.

6. The industrial box top opener of claim 5, wherein the locking mechanism is configured to engage with the retractable shield when the retractable shield is in its extended state and to prevent the retractable shield from being dislodged from the extended state until the shield release button is actuated.

7. The industrial box top opener of claim 5, wherein the locking mechanism includes a locking arm that is configured to engage with the retractable shield to prevent rotation of the retractable shield about an axis of rotation.

8. The industrial box top opener of claim 1, wherein the retractable shield includes a front end having a first surface and a second surface that are generally level with one another and an extended surface that is disposed between the first surface and the second surface and projects outward from the first surface and the second surface, such that the extended surface is not generally level with the first surface and the second surface.

9. The industrial box top opener of claim 8, further comprising a shield release button located on an exterior of the housing body and connected to a locking mechanism that is configured to engage with the extended surface on the first surface of the retractable shield when the retractable shield is in the extended state, such that the retractable shield cannot rotate from the retracted state to the extended state.

10. The industrial box top opener of claim 9, wherein actuating the shield release button shifts the locking mechanism relative to the extended surface, such that the retractable shield can be rotated from the extended state to the retracted state.

11. An industrial box top opener comprising:
a housing body including a first shell coupled to a second shell;
the housing body having an opening that is generally perpendicular to a shelf of the first shell and generally parallel to a sidewall of the second shell;
a blade holder located within an interior of the housing body and configured to receive a utility blade, such that at least a portion of a cutting edge of the utility blade extends from the opening in the housing body when the utility blade has been received by the blade holder;
a retractable shield extending from the opening in the housing body and configured to be partly disposed around the utility blade when in an extended state;
a locking mechanism configured to engage with the retractable shield when the retractable shield is in the extended state to prevent relative rotational movement of the retractable shield relative to the housing body, wherein the retractable shield is configured to move from the extended state to a retracted state where the retractable shield is no longer disposed around the utility blade when the locking mechanism is disengaged; and
a shield release button disposed on an exterior of the housing body and configured to engage with the locking mechanism, such that when the shield release button is actuated the locking mechanism disengages with the retractable shield, such that the retractable shield can be rotated from the extended state to the retracted state.

12. The industrial box top opener of claim 11, further comprising a first grip extending at least partially along a top of the housing body, at least partially along a first side of the housing body, and at least partially along a bottom of the housing body; and
wherein the first grip has a repeating linear pattern with a plurality of valleys.

13. The industrial box top opener of claim 12, further comprising a second grip having a first gripping pattern that extends at least partially along a top surface of a shelf and has a plurality of discrete protrusions disposed about a generally smooth surface.

14. The industrial box top opener of claim 13, wherein each of the plurality of discrete protrusions are generally triangular in shape and are generally uniformly distributed about the generally smooth surface.

15. The industrial box top opener of claim 13, wherein the second grip includes a second gripping pattern that extends at least partially along a portion of a front side of the shelf that is generally perpendicular to the top surface of the shelf and has a repeating pattern of ridges and gullies.

16. The industrial box top opener of claim 11, further comprising a grasping block having a first side and a second side that extend between a generally flat front surface and a generally curved back surface to provide the grasping block with a generally oblong shape.

17. The industrial box top opener of claim 16, wherein a shape of the generally curved back surface of the grasping block is configured to engage a Purlicue of a hand.

18. The industrial box top opener of claim 16, wherein the generally flat front surface of the grasping block includes a first surface depression and a second surface depression separated by a projection extending therebetween.

19. The industrial box top opener of claim 18, wherein the first surface depression is configured to receive a terminal end of a finger and the second surface depression is configured to receive a terminal end of a thumb.

20. The industrial box top opener of claim 18, wherein the projection provides a positioning indicator of the cutting edge of the utility blade extending from the opening of the housing body.

21. The industrial box top opener of claim 11, wherein the blade holder is configured to receive the utility blade at an angle, such that the cutting edge of the utility blade is not parallel with the shelf of the first shell.

22. The industrial box top opener of claim 11, wherein the blade holder is configured to receive the utility blade at an angle, such that the cutting edge of the utility blade is not perpendicular with the sidewall of the second shell when the utility blade has been coupled with the blade holder.

23. The industrial box top opener of claim 11, further including an aperture extending through the sidewall of the first shell.

24. An industrial box top opener comprising:
a housing body;
a blade holder coupled to the housing body and configured to receive a utility blade, such that a cutting edge of the utility blade extends from an opening in the housing body when the utility blade has been received by the blade holder;
a retractable shield configured to cover the cutting edge of the utility blade extending from the housing body when the retractable shield is in an extended state and to expose the cutting edge of the utility blade when the retractable shield is in a retracted state;
a locking mechanism configured to engage with the retractable shield when the retractable shield is in the extended state to prevent rotation of the retractable shield from the extended state to the retracted state;
a first grip including a repeating pattern with a plurality of valleys; and
a grasping block having a top surface and a bottom surface that extend between a generally flat front surface and a generally curved back surface to form a generally oblong shape.

25. The industrial box top opener of claim 24, further comprising a second grip having a first gripping pattern that extends at least partially along a top of the housing body and has a plurality of protrusions.

26. The industrial box top opener of claim 25, wherein the second grip includes a second gripping pattern that extends at least partially along a front surface of a shelf that is generally perpendicular to the top of the housing body; and
wherein the second gripping pattern includes a repeating pattern of ridges and gullies.

27. The industrial box top opener of claim 26, wherein the housing body has a sidewall, and wherein the shelf is generally perpendicular to the sidewall.

28. The industrial box top opener of claim 24, wherein the generally oblong shape of the grasping block is configured to receive a Purlicue of a hand.

29. The industrial box top opener of claim 24, wherein the generally flat front surface of the grasping block includes a first surface depression and a second surface depression.

30. The industrial box top opener of claim 29, wherein the first surface depression and the second surface depression are separated by a projection extending therebetween.

31. The industrial box top opener of claim 24, wherein the blade holder further comprises:
a first shelf configured to engage with a first side of the utility blade adjacent to a front side of the utility blade when the utility blade is coupled to the blade holder;
a second shelf configured to engage with the first side of the utility blade adjacent to a back side of the utility blade when the utility blade is coupled to the blade holder; and
wherein the first shelf extends from a bottom of the housing body a first distance and the second shelf extends from the bottom of the housing body a second distance, such that the cutting edge of the utility blade is not perpendicular to the opening of the housing body.

32. The industrial box top opener of claim 24, wherein the locking mechanism is in an interior of the housing body.

33. The industrial box top opener of claim 24, wherein the locking mechanism includes a locking arm that engages with an extended surface located on a front cover of the retractable shield to prevent rotation of the retractable shield when the retractable shield is in the extended state.

34. The industrial box top opener of claim 33, wherein the extended surface is disposed between a first wall and a second wall located on the front cover of the retractable shield.

35. The industrial box top opener of claim 24, further comprising a biasing mechanism that is coupled to the retractable shield to bias the retractable shield toward the extended state.
